(19) United States
(12) Patent Application Publication
(10) Pub. No.: US 2025/0106594 A1
(43) Pub. Date: Mar. 27, 2025

(54) DEVICE LOCATION BASED ON NON-REPORTING DEVICE LOCATION PROVIDED BY REPORTING DEVICE

(71) Applicant: Kyocera Corporation, Kyoto (JP)

(72) Inventors: Amit KALHAN, San Diego, CA (US); Henry CHANG, San Diego, CA (US)

(21) Appl. No.: 18/832,833

(22) PCT Filed: Feb. 16, 2023
(86) PCT No.: PCT/US2023/013186

§ 371 Date: Jul. 24, 2024

Related U.S. Application Data
(60) Provisional application No. 63/312,333, filed on Feb. 21, 2022.
(60) Provisional application No. 63/313,864, filed on Feb. 25, 2022.

(51) Int. Cl. H04W 4/029; H04W 64/00

(52) U.S. Cl. CPC H04W 4/029; H04W 64/00

(57) ABSTRACT

A reporting user equipment (UE) device receives a wireless signal from a non-reporting UE device and transmits location information to a base station where the location information is at least partially based on the received wireless signal. The base station determines a non-reporting device geographical location of the non-reporting UE device based, at least partially, on the location information without evaluating a signal transmitted from the non-reporting UE device. The location information may indicate the non-reporting device geographical location or may indicate one or more measurements of the wireless signal made by the reporting UE device.

### CLAIM OF PRIORITY

The present application claims the benefit of priority to Provisional Application No. 63/312,333 entitled “Device-to-Device Assisted Positioning”, docket number TPRO 00369 US, filed Feb. 21, 2022, and to Provisional Application No. 63/313,864 entitled “Device-to-Device Assisted Positioning”, docket number TPRO 00370 US, filed Feb. 25, 2022, both assigned to the assignee hereof and hereby expressly incorporated by reference in their entirety.

### CROSS REFERENCE TO RELATED APPLICATIONS

This application is related to PCT Patent Application entitled “DEVICE LOCATION SIGNALING BASED ON NON-REPORTING DEVICE LOCATION PROVIDED BY REPORTING DEVICE”, docket number TUTL 00369B PC, and to PCT Patent Application entitled “MANAGEMENT OF DEVICE LOCATION REPORTING BASED ON NON-REPORTING DEVICE LOCATION PROVIDED BY REPORTING DEVICE”, docket number TUTL 00370 PC, both assigned to the assigned hereof, filed concurrently with this application and incorporated by reference in their entirety herein.

### FIELD

This invention generally relates to wireless communications and more particularly to user equipment (UE) device assisted device location.

### BACKGROUND

Many wireless communication systems employ base stations that provide wireless service to user equipment (UE) devices. The systems often manage communication based on the geographical locations of the UE devices which often move relative to each other and relative to the base stations. In conventional systems, a base station receives signals from a UE device to determine the location typically by evaluating a signal transmitted by the UE device.

### SUMMARY

A reporting user equipment (UE) device receives a wireless signal from a non-reporting UE device and transmits location information to a base station where the location information is at least partially based on the received wireless signal. The base station determines a non-reporting device geographical location of the non-reporting UE device based, at least partially, on the location information without evaluating a signal transmitted from the non-reporting UE device. The location information may indicate the non-reporting device geographical location or may indicate one or more measurements of the wireless signal made by the reporting UE device.

### BRIEF DESCRIPTION OF THE DRAWINGS

FIG. 1A is a block diagram of an example of a communication system including a reporting user equipment (UE) device providing location information to a base station where the base station determines a geographical location of a non-reporting UE device.

FIG. 1B is a block diagram of the system for an example illustrating relative positions and distances between the reporting UE device, the non-reporting UE device, and the base station.

FIG. 1C is an illustration of the relationship between the angle of arrival (AoA) of signals and the device angle between a non-reporting UE device and base station.

FIG. 2 is a block diagram of an example of a base station suitable for use as the base station.

FIG. 3 is a block diagram of an example of a UE device suitable for use as each of the UE devices.

FIG. 4 is a block diagram of the system for an example where the reporting UE device sends a neighbor list (NL) message including the location information.

FIG. 5A is a block diagram of an example of a neighbor list (NL) message suitable for conveying the location information where the location information includes a distance and a link quality to each neighbor device.

FIG. 5B is a block diagram of an example of a neighbor list (NL) message suitable for conveying the location information where the location information includes a distance and a link quality to each neighbor device as well as the serving cell identifier of the serving cell of the neighbor device.

FIG. 5C is a block diagram of an example of a neighbor list (NL) message suitable for conveying the location information where the location information includes a distance, a link quality, a serving cell for each neighbor device as well as a device angle indicator.

FIG. 5D is a block diagram of an example of a neighbor list (NL) message suitable for conveying the location information where the location information includes the link quality and the serving cell for each neighbor device as well as the geographical location of the device.

FIG. 5E is a block diagram of an example of a neighbor list (NL) message suitable for conveying the location information where the location information includes the distance to each neighbor device and an AoA of the wireless signal for each neighbor device.

FIG. 6 is a block diagram of the system for an example where a plurality of reporting UE devices transmits NL messages with location information to a base station.

FIG. 7 is a block diagram of an example of a location information request message.

FIG. 8 is a message flow diagram for an example where each of two reporting devices provides location information to the base station in NL messages.

FIG. 9 is a block diagram of the system for an example where a plurality of UE devices is moving within a geographical area.

### DETAILED DESCRIPTION

It is often advantageous for base stations (gNBs) to have the geographical locations of user equipment (UE) devices or at least have information regarding the distances between specific UE devices. In some circumstances, for example, the base station may use beamforming techniques to direct antenna beams toward a UE device based on the location of the UE device. In other circumstances, the base station may manage communication based on the distance between two or more UE devices. In conventional systems, the base station determines the location of a UE device based on information received directly from the UE device or based on measurements of signals received from the UE device at the base station. In some situations, for example, the base station measures the signal strength and angle of arrival (AoA) of one or more signals transmitted by the UE device. The base station can then determine the geographical location of the UE device using the measured information. In other conventional techniques, the UE device may provide measurements of downlink signals to the base station. For example, a UE device may measure a downlink reference signal transmitted by the base station and provide the measurement to the base station which then can determine the location of the UE device based on the measurements. Conventional techniques are limited in that each UE device must make transmissions to the base station in order for the base station to determine the geographical location of each device. Using the techniques discussed herein, however, communication traffic is reduced since reporting UE devices provide location information of other UE devices to the base station without the need for the other UE devices to transmit signals to the base station.

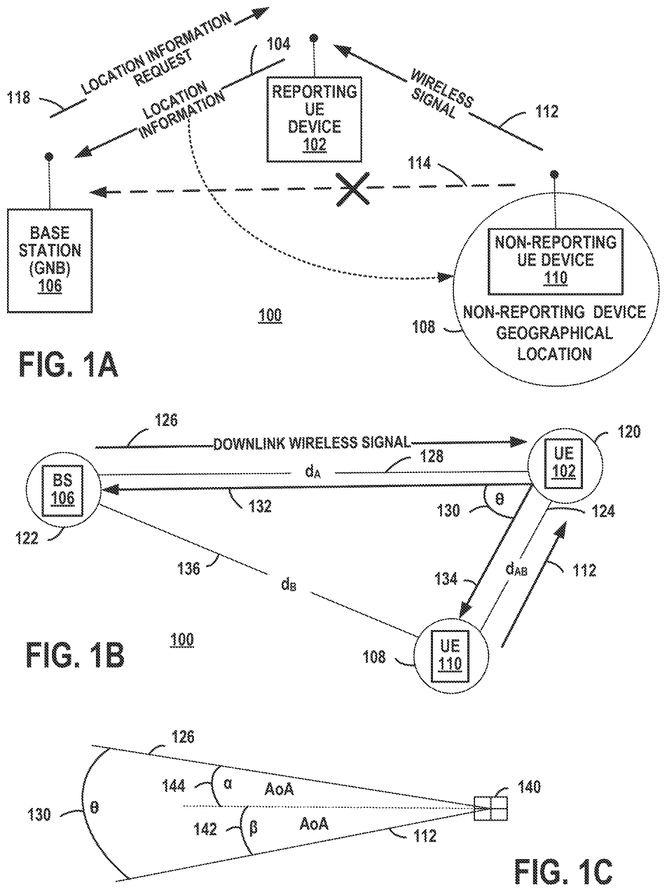

FIG. 1A is a block diagram of an example of a communication system 100 including a reporting user equipment (UE) device 102 providing location information 104 to a base station 106 where the base station 106 determines a geographical location 108 of a non-reporting UE device 110. The reporting UE device 102 receives and measures at least one wireless signal 112 transmitted by the non-reporting UE device 110 and generates the location information 104 based on the measurements. The non-reporting UE device 110, for example, may provide its GPS coordinates in the wireless signal 112 received by the reporting UE device 102. The location information 104 may be Global Navigation Satellite System (GNSS) information of the non-reporting UE device, for example. In some situations, the GPS coordinates of the non-reporting UE device may be used. In some situations, the location information 104 may be information directly indicating the geographical location 108 of the non-reporting UE device 110 as determined by the reporting UE device 102. Where the location information 104 includes GNSS information and/or GPS coordinates, the location information 104 at least includes the latitude and longitude data but may also include altitude and/or velocity information. In other situations, the location information 104 includes measurement values, or other information, based on the measurements taken by the reporting UE device 102 for use by the base station 106 to determine the geographical location 108. For the examples herein, the base station 106 does not use any signal 114 transmitted by the non-reporting UE device 110 to determine the geographical location 108. Accordingly, the non-reporting UE device 110 does not send reference signals or report any measurements to the base station 108 for positioning or location purposes in the examples. Such a technique reduces the transmissions by UE devices in the area thereby minimizing communication traffic congestion and interference as well as resulting in lower latency in acquiring the location information as compared to receiving signals directly from all the UE devices.

Although other techniques may be used to determine which UE device functions as the reporting UE device, the reporting UE device 102 may be selected by the base station 104. The base station 104 may send a location information request 118 to the reporting UE device 102. The location information request 118 may be sent via direct signaling specifically to the reporting UE device 102 or may be in the form of general criteria outlining which UE device should function as a reporting UE device 102. In some situations, the location information request 118 may be broadcast, such as in a System Information Block (SIB), for example. The location information request 118 may also include instructions regarding when and how the location information 104 is to be transmitted. The location information request 118 may be sent over multiple transmissions and/or broadcasts and, in some situations, only updates to the criteria are transmitted.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17). In some situations, the techniques can be applied to UE devices that are not D2D capable but include sufficient functionality to receive and measure wireless signals from other UE devices where the other UE devices may or may not be D2D capable. For the example, the UE devices 102, 110 may be any type of device that can receive signals from, and transmit signals to, base stations and other UE devices. The UE devices typically operate in the communication system 100 that includes a plurality of base stations that each provide wireless service within a service area. As discussed below, it may be possible that the reporting UE device 102 and the non-reporting UE device 110 are served by different base stations and/or cells. A UE device may be in one of at least three radio resource control (RRC) states including RRC CONNECTED, RRC IDLE, and RRC INACTIVE. A UE device may be in IDLE mode relative to the base stations when communicating using sidelink (D2D) resources. As discussed below, the communication resources used to transmit the location information 104 may depend on the state of the reporting UE device 102.

The location information 104 may be conveyed to the base station 106 using any of various techniques. In one example, the reporting UE device 102 maintains a neighbor list (NL) which includes the neighbor UE devices of the reporting UE device 102 where at least some of the neighbor UE devices are non-reporting UE devices 110. The NL may include the locations of the non-reporting UE devices or parameters based on measurements made by the reporting UE device for each UE device in the NL. The NL may also include other parameters such as a Cell ID of the serving cell of each UE device. The location information 104 may be transmitted via direct signaling from the reporting UE device to the base station 106. The NL may also be transmitted using sidelink (SL) resources as a SL (D2D) signal where the base station 106 monitors the SL resources in order to receive the location information 104. In one example, a reporting UE device 102 transmits the location information 104 via dedicated signaling when in the RRC-CONNECTED mode and otherwise transmits the location information 104 via SL message using SL (D2D) resources such as when in the IDLE or INACTIVE states. In some situations, the reporting UE device 102 only transmits the location information 104 when in the CONNECTED state and, therefore, transitions from IDLE or INACTIVE to CONNECTED in order to transmit the location information 104.

The wireless signal 112 can be any type of electromagnetic, acoustic, infrared or light signal. Although in the examples discussed herein the neighbor device or non-reporting device includes a transmitter that transmits the wireless signal, other methods can be used to measure a signal from the UE device. The wireless signal 112 may be a reflected signal transmitted by the reporting UE device 102 or by another source. For example, sonar, radar, and lidar can be used by the reporting UE device 102 to generate a wireless signal (electromagnetic, acoustic or laser) that reflects off of the neighbor device such that the reflected signal is the wireless signal 112 that is received by the reporting UE device and measured. In addition, the wireless signal 112 may be a reflected signal of signal provided another source. In some situations, a camera can be used to capture a light signal reflecting off of an object near the non-reporting device. Such techniques may be more appropriate for situations where the non-reporting device is associated with a vehicle, for example. The reporting UE device 102, therefore, may include location processing capabilities to evaluate received wireless signals and determine, or at least estimate, the location 108 of the non-reporting UE device 110. Techniques utilizing image processing and/or machine vision technology, for example, may be used by the reporting UE device 102 to determine the location 108 of the non-reporting UE device 110. Any combination of measurements, calculated values, estimates and/or other information may be forwarded to the base station 106 to allow the base station 106 to determine the location 108. In addition, the base station 106 may use other entities to process the location information 104 in order to at least assist in determining the location 108. For example, the reporting UE device 102 may send measurements or values to the base station 106 in the location information 104 and the base station 106 may use a machine vision processor/entity to process the information to determine the location 108.

For the examples discussed herein, the non-reporting UE device 110 transmits an electromagnetic signal in accordance with the signaling and channels of the system 100. The wireless signal 112 may be beacon signal or reference signal that contains little or no data or may be a data signal. In some situations, the wireless signal 112 is a control signal. The wireless signal 112 may be an uplink signal transmitted to a base station 106, a sidelink signal (D2D signal) transmitted to the reporting UE device 102 and/or another UE device either via direct signaling transmission, broadcast transmission, or groupcast transmission.

FIG. 1B is a block diagram of the system 100 for an example illustrating relative positions and distances between the reporting UE device 102, the non-reporting UE device 110, and the base station 106. The geographical locations 108, 120, 122 of the non-reporting UE device 110, the reporting UE device 102, and the base station 106 are represented by circles around the blocks representing the devices 102, 110 and base station 106 in FIG. 1B. For the example, the reporting UE device 102 performs measurements on one or more wireless signals 112 to provide information that can be used to at least determine a distance (d_{AB}) 124 between the reporting UE device 102 and the non-reporting UE device 110. In some situations, the reporting UE device 102 also performs measurements on a downlink wireless signal 126 transmitted by the base station 106 which can be used to determine the distance (d_{A}) 128 between the base station 106 and the reporting UE device 102. Where the reporting UE device 102 has multiple antennas and the appropriate capabilities, the reporting UE device 102 also determines an angle of arrival (AoA) of the wireless signal 112 and, in some situations, the AoA of a downlink signal transmitted from the base station 106. With both the AoA of the wireless signal 112 and the AoA of the downlink signal 126, the reporting UE device may determine the device angle, θ, 130. The device angle, θ, 130 is the angle between a base station direction 132 and non-reporting device direction 134 where the base station direction 132 is from the reporting UE device 102 to the base station 106 and the non-reporting device direction 134 is from the reporting UE device 102 to the non-reporting UE device 110. The non-reporting device geographical location 108 can be determined based on the distance d_{A} 128, distance d_{AB} 124, and the device angle, θ, 130. For example, d_{B}=\sqrt{d_{A}²+d_{AB}²+2d_{A}d_{AB} cos θ}.

In some situations, the reporting UE device 102 determines the location 108 of the non-reporting UE device 110 and stores the information for transmission to the base station 102 at the appropriate time. In other situations, the reporting UE device 102 only stores and transmits the distance, d_{A}, 128 and the device angle, θ, 130 to the base station 106. In still other situations, the reporting UE device sends the AoA and the signal strength of the wireless signal. In such situations, the base station 102 determines the distance, d_{A}, 128 and calculates the location 108 of the non-reporting UE device 110. Regardless of the specific contents of the location information 104, however, the base station 106 does not need to receive information or measure signals transmitted from the non-reporting UE device 110 to determine the location 108.

FIG. 1C is an illustration of the relationship between the angle of arrival (AoA) of signals and the device angle 130 between a non-reporting UE device 110 and base station 106. In some situations, the reporting UE device 102 may include multiple antennas, multiple element antenna, an antenna array, directional receive antenna, or other suitable antenna structure capable of measuring an AoA of a signal. For the example, a AoA capable antenna 140 of the reporting UE device 102 is utilized to determine or estimate the AoA, β, 142 of the wireless signal 112 and the AoA, α, 144 of a downlink signal 126 as received at the reporting UE device 102. The AoA of a signal may be determined relative to a reference direction 146. Although the reference direction 146 is represented by a dashed line between the signals 126, 112 in FIG. 1C, the reference may be in any direction or orientation. The reference direction 146 may be geographical north and positive in a counterclockwise direction, for example. The reporting UE device estimates or determines the AoA, β, 142 of the wireless signal 112 and the AoA, α, 144 of the downlink signal 126 and, based on the results, determines the device angle, θ, 130.

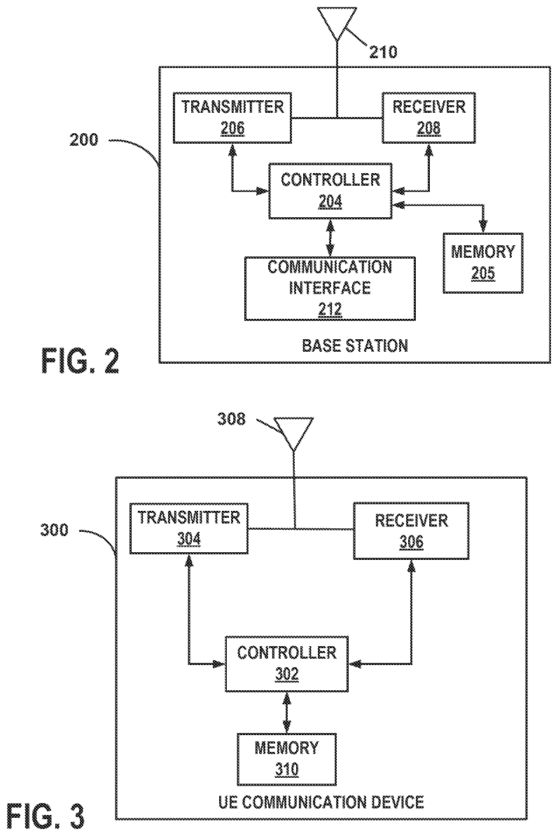

FIG. 2 is a block diagram of an example of a base station 200 suitable for use as any one of the base stations 106, 408. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base station 106 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory 205. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. For the examples herein, the antenna 210 includes multiple transmit and receive antennas to allow for performing AoA measurements.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

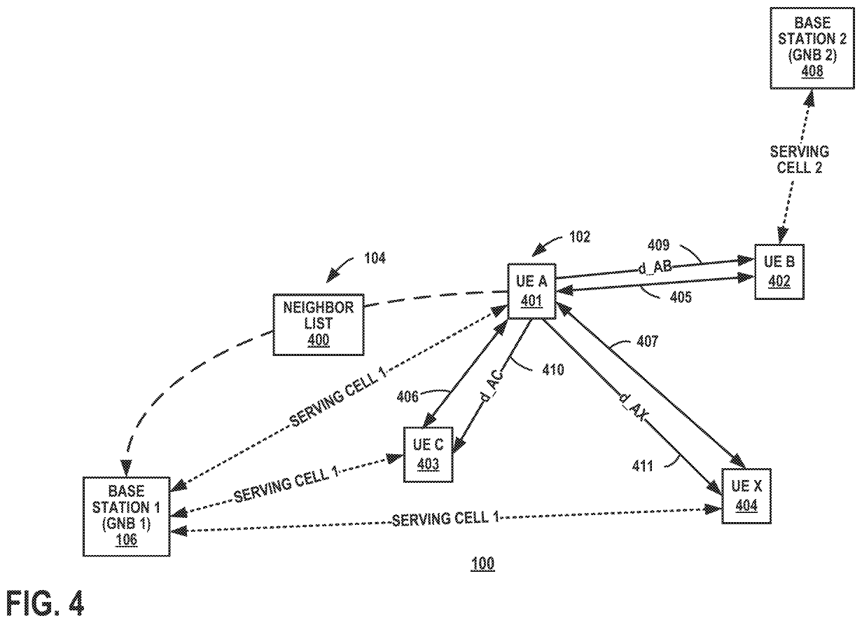

FIG. 3 is a block diagram of an example of a UE device 300 suitable for use as each of the UE devices 102, 110, 401-404, 602, 603. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas. Multiple receive antennas facilitate AoA measurements. The antenna 308, therefore, may be an AoA capable antenna 140 discussed above.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

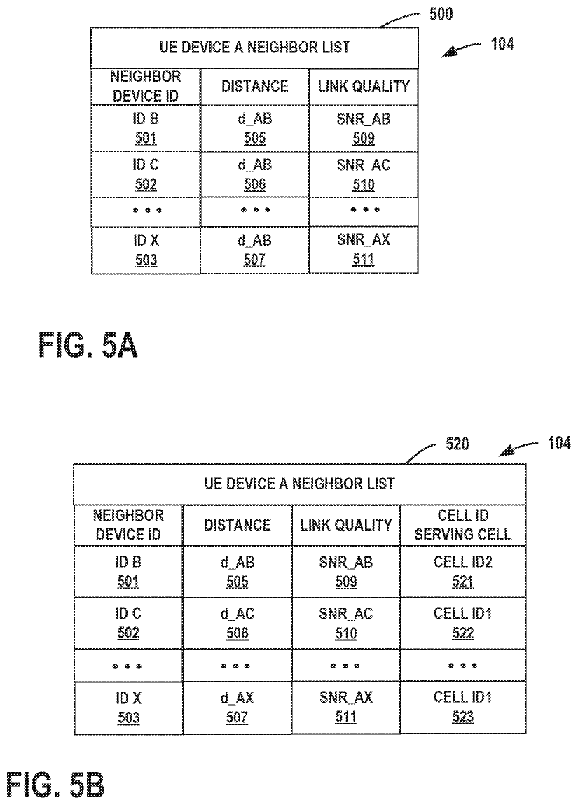

FIG. 4 is a block diagram of the system 100 for an example where the reporting UE device 102 sends a neighbor list (NL) message 400 including the location information 104. For the example, UE device A 401 is a reporting UE device 102 and UE device B 402, UE device C 403, and UE device X 404 are neighbor devices of UE device A 401. For the example, the quality of each of the communication links 405-407 between UE device A and the neighbor devices 402-404 is above a threshold. Other nearby devices (not shown) that do not meet the required criteria are not included in the neighbor list 400 for the example. For the example, the criteria for determining whether a neighbor device should be included in the NL 400 is a minimum link quality of the communication link between the reporting UE device and the neighbor device. Other criteria may also be used. The distance between the two devices may be used in some circumstances. Although three neighbor devices are shown in FIG. 4, the UE device A 401 may have any number of neighbor devices.

In some situations, all of the neighbor devices listed in the neighbor list 400 may be served by the same cell while, in other situations, one or more neighbor devices may be served by different cells. Accordingly, the serving cell of a neighbor device may be the same as, or different from, the serving cell of the reporting UE device A 401. For the example of FIG. 4, UE device A 401, UE device C 403, and UE device X 404 are served by Cell 1 provided by base station 1 106 and UE device B 402 is served by Cell 2 provided by base station 2 408.

The UE devices 401-404 may be in any one of the RRC states including RRC_CONNECTED, RRC_IDLE and RRC_INACTIVE. For the example, the neighbor list (NL) 400 is transmitted in an uplink channel to the base station 106 when the reporting UE device A 401 is in RRC_CONNECTED. When the reporting UE device A 401 is in IDLE or INACTIVE, the UE device A 401 transmits the neighbor list 400 over a D2D channel. In some situations, if certain criteria for reporting the NL 400 is satisfied when the reporting UE device is in IDLE or INACTIVE, the reporting UE device transitions to RRC CONNECTED and transmits the NL while in the CONNECTED state. The base station 106 monitors the D2D channel to receive the neighbor list 400 in such situations. As discussed below, the D2D channel used for transmitting NLs may be a dedicated resource for NL transmissions.

Although the neighbor devices 402-404 may be non-reporting UE devices 110, one or more of the neighbor devices in the neighbor list 400 may also function as reporting UE devices 102 and transmit a neighbor list (not shown in FIG. 4). As discussed below, such a scheme may be utilized when the base station 106 is tracking a UE group of a platoon and multiple reporting UE devices are selected. One reporting UE device may be a cluster head of the platoon and one or more other UE devices in the platoon may also be reporting UE devices. If the cluster head UE moves away from the platoon, the base station 106 may designate one of the other reporting UE devices as the cluster head UE device.

The neighbor list (NL) 400 includes location information which, either directly or indirectly, at least provides the distances between the reporting UE device A and the neighbor UE devices. Accordingly, the NL 400 allows the base station 106 to determine the distance (d_AB) 409 between UE device A 401 and UE device B 402, the distance (d_AC) 410 between UE device A 401 and UE device C 403, and the distance (d_AX) 410 between UE device A 401 and UE device X 404. The NL 400 may also directly or indirectly provide the geographical location of each neighbor device. As discussed above, for example, the location information 104 may include AoA indicator or other information that can be used by the base station 106 to determine the location. Some examples of NLs are discussed below.

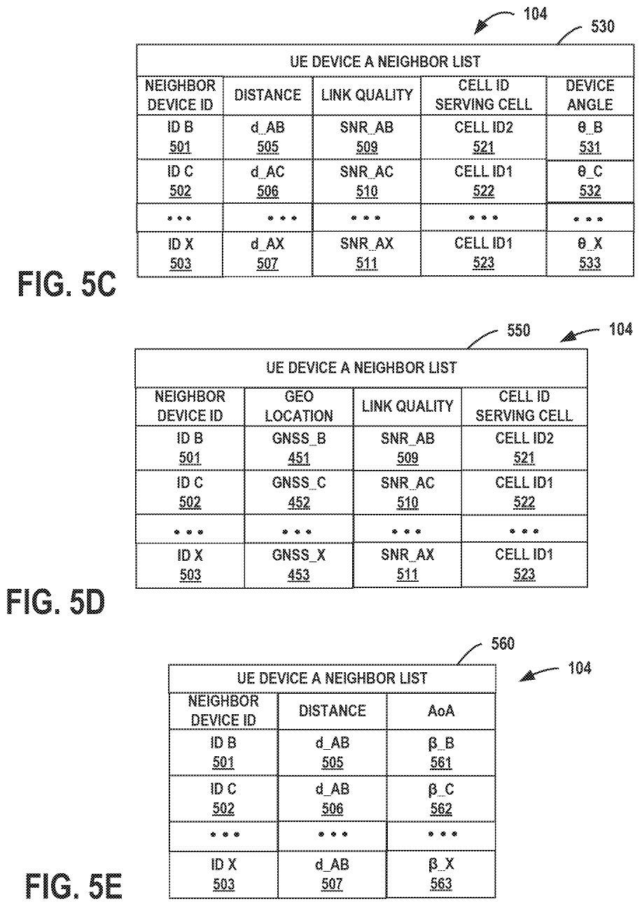

FIGS. 5A-5D are block diagrams of examples of neighbor list (NL) 400 messages suitable for transmitting location information 104. The examples include data for a plurality of neighbor devices (UE device B 402, UE device C 403, and UE device X 404) of UE device A 401 in FIG. 4. The neighbor lists (NLs) may include data for any number of neighbor devices. Each neighbor list in FIGS. 5A-5D includes blocks with three dots indicating that the neighbor list (NL) may include more than three neighbor devices. Each neighbor list (NL) discussed below may be transmitted to the base station 106 as a control message and/or as part of a Channel State Information Reference Signal (CSI-RS) report, as well as with other techniques. The location information 104 transmitted by a reporting UE device 102 related to a non-reporting UE device 110 is based on the latest available location information for the non-reporting device 110 and may not reflect the current location of the non-reporting UE device 110 at the time of the transmission of the location information 104.

FIG. 5A is a block diagram of an example of a neighbor list (NL) message 500 suitable for conveying the location information 104 where the location information 104 includes a distance and a link quality to each neighbor device. The NL message 500 includes a plurality of neighbor device identifiers (IDs) 501-503, a plurality of distances 505-507 and a plurality of link quality indicators 509-511. Where the neighbor device IDs 501-503 are Layer-2 (e.g., upper layer IDs for D2D), a mapping of the Layer-2 IDs to the network identifiers is available to the base station. For example, the core network (CN) may provide the mapping between each neighbor device ID to the appropriate CONN Radio Network Temporary Identifier (C-RNTI), INACTIVE-RNTI (I-RNTI) and SAE-Temporary Mobile Subscriber Identity (S-TMSI) of a UE device in IDLE. The ID B 501 identifies the neighbor UE device B 402. Similarly, ID C 502 and ID X 503 identify the neighbor UE device C 403 and the neighbor UE device X 403, respectively. Associated with each neighbor device identifier are a distance and a link quality. The distance d_AB 505 is indicative of the distance between the UE A 401 and the UE device B 402, the distance d_AC 506 is indicative of the distance between the UE A 401 and the UE device C 403, and the distance d_AX 507 is indicative of the distance between the UE A 401 and the UE device X 404. For the example, the distances 505-507 are determined based on the transmission and reception power levels of wireless signal. As part of the D2D protocol, the UE devices 401-404 transmit discovery channel (sidelink) state information resource signals (sidelink CSI-RS) to their neighbor device where the transmission power level of the signals is network configurable. The UE device 401 decodes the discovery messages and determines the received power level. The distance is determined based on received power level and the transmit power level. The transmission power level of the discovery signals is conveyed to the UE devices via a System Information Block (SIB) transmitted by the base station, in some situations. In other situations, the neighbor UE device informs the UE device 401 of the transmission power of the discovery reference signals that are being measured. Other methods may be used to allow the reporting UE device A 401 to know the transmission power of the signal that is measured. The reporting UE device 102 may determine the transmission power level using open loop power control (OLPC), for example. In some circumstances, a neighbor UE device may provide a sidelink CSI-RS report to the reporting UE device A 401 where the UE device A 401 determines that distance based on the report.

The link quality indicator 509-511 for each neighbor device 402-404 is determined by the UE device A 401 based on at least one received wireless signal, such as reference signal. The link quality indicator 509 is indicative of the quality of the communication link 405, the link quality indicator 510 is indicative of the quality of the communication link 406, and the link quality indicator 511 is indicative of the quality of the communication link 407. For the example, the quality indicators are signal-to-noise (SNR) levels. Other parameters can be used to indicate the link quality.

FIG. 5B is a block diagram of an example of a neighbor list (NL) message 520 suitable for conveying the location information 104 where the location information 104 includes a distance and a link quality to each neighbor device as well as the serving cell identifier of the serving cell of the neighbor device. Therefore, in addition to the indicators and values discussed with reference to FIG. 5A, the neighbor list 520 includes a Cell ID 521-523 for each neighbor device 402-404. Cell ID 1 522, 523 identifies the cell provided by base station 1 106 that is the serving cell of UE device 403 and UE device 404. Cell ID 2 521 identifies the cell provided by base station 2 408 that is the serving cell of UE device 402. Where the Cell ID is based on a Physical Layer Cell ID, the Cell ID 521, 522, 523 may not uniquely identify the cell but nonetheless provides sufficient information for the base station to identify the serving cell. Where the Cell 521-523 is based on a NR Cell Global Identity (NCGI), the Cell ID is globally unique.

FIG. 5C is a block diagram of an example of a neighbor list (NL) message 530 suitable for conveying the location information 104 where the location information 104 includes a distance, a link quality, a serving cell for each neighbor device as well as a device angle indicator. Therefore, in addition to the indicators and values discussed with reference to FIG. 5A and FIG. 5B, the neighbor list 530 includes a device angle indicator 531-533 for each neighbor device 402-404. As discussed above, a device angle indicator is any value or parameter that conveys the angle between the base station direction 132 and non-reporting device direction 134 where the base station direction 132 is from the reporting UE device 102 to the base station 106 and the non-reporting device direction 134 is from the reporting UE device 102 to the non-reporting UE device 110. Therefore, the device angle between the base station direction and UE device B 402 direction is indicated by θ_B 531, the device angle between the base station direction and UE device C 403 direction is indicated by θ_C 532, and the device angle between the base station direction and UE device X 404 direction is indicated by θ_X 533. With the location information included in the NL message 530, the base station can determine the geographical locations of the devices 402-404.

FIG. 5D is a block diagram of an example of a neighbor list (NL) message 540 suitable for conveying the location information 104 where the location information 104 includes the link quality and the serving cell for each neighbor device as well as the geographical location of the device. Therefore, as compared to the NL message 530, the NL message 540 replaces the distance and device angle indicator with the geographical location. For the example, the geographical location parameters are GNSS parameters. Therefore, the geographical location of UE device B 402 is indicated by GNSS_B 451, the geographical location of UE device C 403 is indicated by GNSS_C 452 and the geographical location of UE device X 404 is indicated by GNSS_X 453. The GNSS parameters include at least longitude and latitude and may also include altitude and velocity. Other parameters that indicate the geographical location may also be used.

FIG. 5E is a block diagram of an example of a neighbor list (NL) message 560 suitable for conveying the location information 104 where the location information 104 includes the distance to each neighbor device and an AoA of the wireless signal for each neighbor device. For the example of FIG. 5E, therefore, the AoA is indicated by β_B 561 for the UE device B 402, the AoA is indicated by β_C 562 for the UE device C 403, and the AoA for UE device X 404 is indicated by β_X 563. Various other parameters, indicators and values can be included in the NL message in other situations and the above NL messages 500, 520, 530, 550, 560 can be modified/and or combined to create other NL messages.

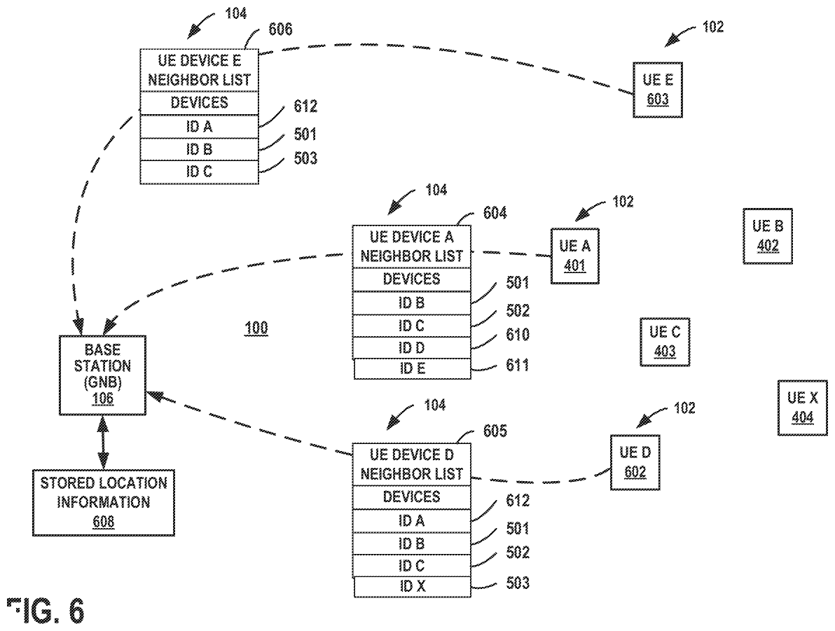

FIG. 6 is a block diagram of the system 100 for an example where a plurality of reporting UE devices 401, 602, 603 transmit NL messages 604-606 with location information to a base station 106. Each of the NL messages 604-606 may be any one of the NL message examples discussed above, combination or modification thereof. For the example, the NL messages 604-606 include information that overlaps with other NL messages 604-606. The base station 106 maintains the location information 608 received from each reporting UE device 401, 602, 603. The stored location information 608 at the base station 106 may be used by the base station 106 to track UE devices, select the reporting UE devices, and otherwise manage the location information reporting procedure. Where a UE device cluster including several UE devices traveling together, for example, the base station 106 may select a cluster head UE device to be the reporting UE device 102. In some situations, more than one UE device is selected as a reporting UE device from the cluster to report location information 104. The base station 106 may filter or otherwise process the location information 104 received in multiple NL messages to map the locations of the UE devices.

Each of the reporting devices 401, 602, 603 is an example of the reporting device 102 discussed above and sends location information 104 to the base station 106 in a NL message 604-606. The NL message 604 transmitted by the UE device A 401 includes UE device IDs identifying the neighbor devices of the UE device A as well as the associated location information for each neighbor device. For the example, the NL message 604 includes a UE B identifier 501, UE C identifier 502, UE D identifier 610 and a UE E identifier 611. Accordingly, the NL message 604 provides location information for neighbor devices including UE device B 402, UE device C 403, UE device D 602 and UE device E 603. The NL message 605 includes a UE A identifier 612, the UE B identifier 501, the UE C identifier 502, and a UE X identifier 503. Accordingly, the NL message 605 provides location information for neighbor devices including UE device A 401, UE device B 402, UE device C 403, and UE device X 503.

The NL message 606 includes a UE A identifier 612, the UE B identifier 501, and the UE C identifier 502. As a result, the base station 106 receives location information 104 for the UE A device, UE B device, the UE C device from multiple NL messages 604-606. Each NL message may include location information that is less than adequate for the base station 106 to determine the location of the UE device. When the information from multiple NL messages is processed, however, the location may be determined. For example, the base station 106 can determine the location of a neighbor UE device of multiple reporting UE devices based on the distance provided by each reporting UE device and the location of each reporting UE device.

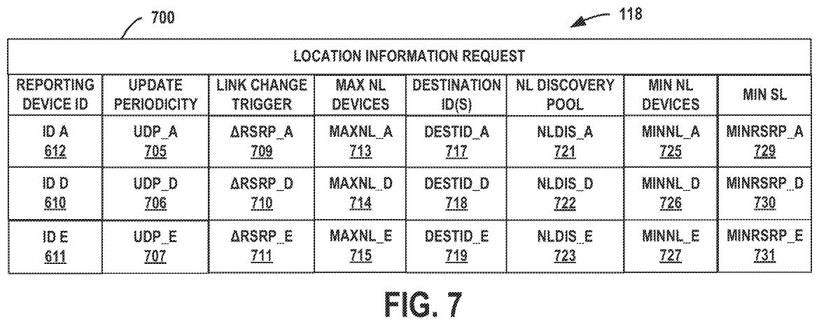

FIG. 7 is a block diagram of an example of a location information request message 700. The location information request message 700 may be transmitted from the base station via direct signaling or via broadcast message, such as via an SIB. The location information request message 700 at least includes reporting device identifiers 610-612 that identify the UE devices (UE A, UE D and UE E) that are instructed to provide location information regarding other UE devices to the base station 106. Accordingly, the reporting device identifiers 610-612 identify the reporting UE devices. Although for the example of FIG. 7 the reporting UE devices are uniquely identified by the reporting device IDs 610-612, the reporting UE devices may be identified based on criteria or other values in other situations. For example, rather than specifically identifying the reporting UE devices, the location information request may identify a geographical area where UE devices within the area are instructed to report location information regarding neighbor devices. The reporting device identifiers 610-612 may be UE IDs.

The location information request message 700 may also include several parameters that allow the base station 106 to manage location information reporting. One or more parameters may be omitted and one or more other parameters not shown in the example may be included in the location information request message 700 in some situations. For example, one or more of the parameters may be preconfigured and are not sent in a location information message. The parameters discussed, as well as other parameters that may be included in the information request 700, function as indicators indicating the criteria for measuring, creating, managing, and transmitting location information as established by the base station. Although the example of FIG. 7 is related to location information transmitted by the reporting UE devices in NL messages, a location information request transmitted by the base station may be directed to other types of location information creation, measurement, management, and transmission.

The update periodicity indicators 705-707 indicate how often the reporting UE device should transmit the location information. For the example, each update periodicity indicator 705-707 is associated with a specific reporting UE device. In some situations, a single update periodicity indicator may be used for all of the reporting UE devices. Accordingly, the location information request message 700 may include only a single value for the update periodicity indicator. For the example of FIG. 7, the update periodicity indicator indicates how often a NL message is transmitted by the reporting UE device. For the example of FIG. 7, the update periodicity indicator UDP_A 705 provides the update periodicity for the UE A device 401, the update periodicity indicator UDP_D 706 provides the update periodicity for the UE D device 602 and the update periodicity indicator UDP_E 706 provides the update periodicity for the UE E device 603.

Link change trigger indicators 709-711 indicate when the reporting UE device should provide a location information report (e.g., NL message) based on a detected change in communication link quality. For example, if the UE A device 401 detects a change in link quality to one of its neighbor devices that is greater than the ΔRSRP_A 709 link change trigger, the UE A device 401 sends a location information update (e.g., updated NL message) to the base station 106. Such an update may be in addition to the update periodicity schedule indicated by UDP_A 705. The link change trigger ΔRSRP_D 710 provides the trigger threshold for the UE D device 602 and the update link change trigger ΔRSRP_E 711 provides the trigger threshold for the UE E device 603. In some situations, a link change trigger may be used for all of the reporting UE devices. Accordingly, the location information request message 700 may include only a single value for the link change trigger to be used by all reporting UE devices.

The maximum number neighbor devices parameter 713-717 limits the number of neighbor devices included in the location information. Therefore, the number of devices listed in neighbor list messages transmitted by the UE A device 401 are limited to the value specified by MAXNL_A 713. Similarly, UE D device 602 limits its NL message to including a number of devices based on MAXNL_D 714 and UE E device 603 limits its NL message to including a number of devices based on MAXNL_E 715. In some situations, a maximum NL device parameter may be used for all of the reporting UE devices. Accordingly, the location information request message 700 may include only a single value for a maximum NL device parameter to be used by all reporting UE devices. For the example, each reporting UE device selects the closest neighbor devices and/or neighbor devices with the best link quality to include in the NL and, if the reporting device has more neighbor devices than specified by the maximum NL device parameter, only the top priority devices are included in the NL. Therefore, if the reporting UE device identifies seven neighbor devices and the maximum NL device parameter is 6, the reporting UE device limits the NL to six devices and omits the neighbor device with the lowest priority. Where the reporting UE device determines the distance to each neighbor device, the neighbor devices may be prioritized based on distance from least to greatest and the only the top neighbor devices with the least distances are included in the NL. The base station may determine the maximum NL device parameters based on several factors, such as the number of reporting UE devices in an area, the communication traffic load at the base station, and/or the available communication resources. For example, where the NL messages are transmitted via RRC messages, NLs with a large number of neighbor devices may need to be segmented and sent over more than one RRC message. As a result, limiting the number of neighbor devices in the NL may reduce the number of transmitted RRC messages.

The destination identity (ID) indicator 717-719 identifies at least one destination ID that is selected for transmission of the location information. Destination IDs are used in D2D transmissions where the intended recipient of the D2D transmission is identified by the destination ID. Typically, the destination ID indicates whether the transmission is a broadcast or unicast transmission or is transmission intended for a group. The destination IDs 717-719 may be different and some may be the same for two or more reporting UE devices. In some situations, the same device IDs may be used for all of the reporting UE devices. Accordingly, the location information request message 700 may include only a single value or a single set of values for the destination ID to be used by all reporting UE devices. In some situations, the destination ID provides an additional or alternative parameter for identifying the neighbor UE devices. The destination ID may be the Layer 2 ID of the neighbor UE.

Each NL discovery pool indicator 721-723 identifies one or more discovery resources for transmission of the location information. Each NL discovery pool indicator 721-723, therefore, may identify a pool of discovery resources reserved only for NL message transmissions. The discovery process is time-critical since the UE devices are moving and the locations are changing over time. Utilizing a dedicated NL discovery resource pool facilitates timely discovery transmissions. The resources identified by each NL discovery pool indicator 721-723 may the same or different for each reporting UE device. In some situations, the same indicators 721-723 may be used for all of the reporting UE devices. Accordingly, the location information request message 700 may include only a single value or a single set of values for the NL discovery pool indicator to be used by all reporting UE devices.

The minimum number neighbor devices parameter 725-727 requires that a transmitted location information, such as NL, have a minimum number of neighbor devices. For the example, the number of neighbor devices is counted as the number of neighbor devices meeting the other criteria for inclusion in the location information. In some situations, however, the number of neighbor devices is counted as the total number of neighbor devices detected by the reporting UE device. For the example, therefore, the reporting UE device does not transmit the location information when the total number of neighbor devices listed in the NL is less than the minimum threshold indicated by the minimum number neighbor devices parameter 725-727. The minimum number of devices listed in neighbor list messages transmitted by the UE A device 401 is limited to the value specified by MINNL_A 725. Similarly, UE D device 602 only transmits an NL message that includes a number of devices greater then or equal to MINNL_D 726 and UE E device 603 transmits NL messages that include a number of devices greater than or equal to MINNL_E 727. In some situations, a minimum NL device parameter may be used for all of the reporting UE devices. Accordingly, the location information request message 700 may include only a single value for a minimum NL device parameter to be used by all reporting UE devices.

Minimum link quality indicators 729-731 indicate the minimum link quality of the communication link to a neighbor device required for the neighbor device to be included in transmitted location information, such as an NL message. For the example, the minimum link quality parameter is a minimum RSRP value. Other types of values, however, can also be used. Signal to noise ratio (SNR) and other ratios, for example, may be sued in some situations. Although for the example the link quality is related to the sidelink communication link between the neighbor device and the reporting UE device, the link quality may be related to a non-communication link in some situations. Where the wireless signal 112 that is measured by the reporting UE device is a sound or light signal, for example, the link quality may be related to the distance between the neighbor device and the reporting UE device. The minimum link quality parameter, therefore, may indirectly signify the quality of the communication link between the two devices. In addition, the link quality parameter may relate to a communication link that is not established in some situations. For the example for FIG. 7, UE A device 401 only includes a neighbor device in a transmitted NL where the quality of the communication link between the reporting UE device 401 and the neighbor device is greater than or equal to MINRSRP_A 729. The UE D device 602 only includes a neighbor device in a transmitted NL where the quality of the communication link between the reporting UE device 602 and the neighbor device is greater than or equal to MINRSRP_D 730. The UE E device 603 only includes a neighbor device in a transmitted NL where the quality of the communication link between the reporting UE device 603 and the neighbor device is greater than or equal to MINRSRP_E 731. In some situations, a single minimum link quality may be used for all of the reporting UE devices. Accordingly, the location information request message 700 may include only a single value for the link quality parameter to be used by all reporting UE devices.

The various parameters discussed with reference to FIG. 7 may be transmitted directly to a specific UE device via dedicated signaling or may transmitted to multiple UE devices via dedicated signaling or a broadcast message. Parameters in addition to those discussed with reference to FIG. 7 may be used and some parameters may be omitted. Modifications to the parameters as well as combinations of parameters may also be used in some situations. As discussed above, at least some parameters may be preconfigured. In addition, at least some parameters may be sent to a UE device in different and/or separate messages or over control signals.

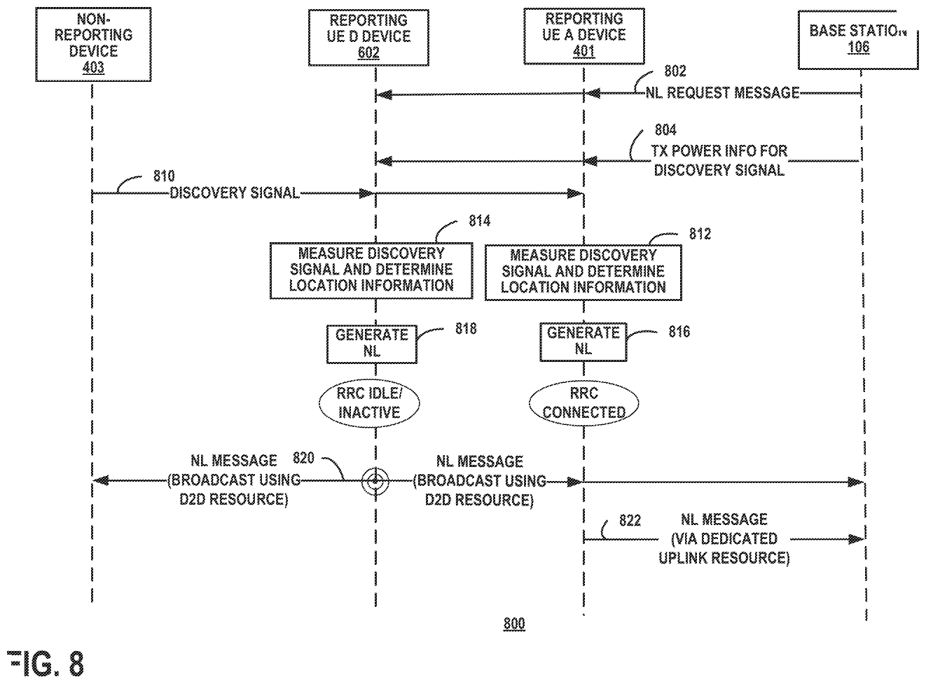

FIG. 8 is a message flow diagram 800 for an example where each of two reporting devices 401, 602 provides location information to the base station 106 in NL messages 400. The message flow of FIG. 8 is one example of a message flow scenario for the communication system 100 discussed above.

At transmission 802, the base station 106 transmits a NL request message to the reporting devices 401, 602. For the example, the NL request message is broadcast in a SIB and at least identifies the UE devices that are instructed to provide location information of other UE devices. As discussed above, the NL request message can be sent to specific UE devices via dedicated signaling in other examples.

At transmission 804, the base station provides the transmission power information regarding the discovery signals (or other references signals) that will be transmitted by neighbor devices. For the example, the base station indicates a fixed power level of the wireless signal either in a SIB or via dedicated signaling. In some situations, other parameters provided by the base station may be used by the UE device to determine the power level of the wireless signal. In some situations, the transmission 804 can be omitted and the neighbor devices transmitting the discovery signals provide the transmission power information to the reporting UE devices. In other situations, the UE device may determine the power level using open loop power control (OLPC) and other information.

At transmission 810, a non-reporting neighbor device 502 sends a discovery signal which is received by the reporting UE devices 401, 602. The reporting UE A device 401 measures the discovery signal at event 812 and the reporting UE D device 601 measures the discovery signal at event 814. Each reporting UE device at least measures the received signal power. In some situations, the reporting UE device measures the quality of the discovery signal to determine the D2D communication link quality. Where the device has multiple antennas and the appropriate capabilities, the reporting UE device also measures the AoA of the received discovery signal.

At event 816, the reporting device UE A device 401 generates a neighbor list (NL). The NL includes at least UE ID of the non-reporting UE device 403 as well as the calculated distance between the reporting UE A device 401 and the non-reporting UE device 403. In some situations, the NL includes the received signal power of the discovery signals without including the calculated distance. For the example, the NL includes all of the neighbor devices that meet a minimum threshold of link quality and includes the distance to each neighbor device as well as a link quality indicator for each communication link to each neighbor device.

At event 818, the reporting device UE D device 602 generates a neighbor list (NL). The NL includes at least UE ID of the non-reporting UE device 403 as well as the calculated distance between the reporting UE D device 602 and the non-reporting UE device 403. In some situations, the NL includes the received signal power of the discovery signals without including the calculated distance. For the example, the NL includes all of the neighbor devices that meet a minimum threshold of link quality and includes the distance to each neighbor device as well as a link quality indicator for each communication link to each neighbor device.

The reporting UE device D is in either the IDLE or INACTIVE state and the reporting UE device A 401 is in the CONNECTED state in the example. The reporting UE device D 602 broadcasts a NL message at transmission 820 using D2D resources assigned by the base station 106. For the example, the resources are specified in the NL request message received at transmission 802 although other techniques can be used to convey the resources for broadcasting the NL message. The NL message can be received by all of the neighbor devices of the UE D device 602. The base station 106 also receives the broadcasted NL message. The NL message includes at least a portion of the NL generated at event 818.

The reporting UE device A 401 sends an NL message at transmission 822 using dedicated uplink resources assigned by the base station 106. For the example, the resources are specified in the NL request message received at transmission 802 although other techniques can be used to convey the resources for direct signaling of the NL message. The NL message includes at least a portion of the NL generated at event 816.

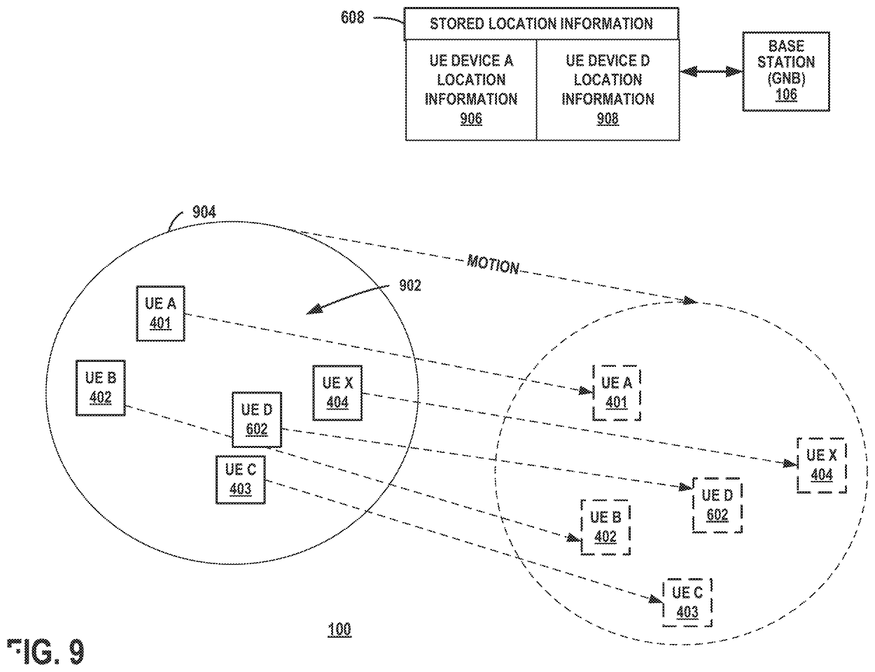

FIG. 9 is a block diagram of the system 100 for an example where a plurality of UE devices 902 is moving within a geographical area 904. For the example, the group of UE devices is a cluster where each UE device 401-404, 602 is sufficiently close to every other UE device to communicate directly. In one situation, the cluster is vehicle platoon traveling in the same direction on a roadway. The base station 106 tracks the locations of all of the UE devices 401-404, 602 in the group based on location information received from at least one reporting UE device 401 in the group. For the example, the maintains stored location formation 608 that includes UE device A location information 906 and UE device D location information 908.

The base station 106 selects one or more UE devices that should report the location information of their neighbor devices from the plurality of devices 902. The selected UE devices then perform the functions of a reporting UE device 104. The number for UE devices may selected based on at least factors related to the communication traffic-load at the base station. With higher traffic loads, the base station 106 may select fewer UE devices. With lighter communication traffic, the base station 106 may select a larger number of reporting UE devices. The number of reporting UE devices may be based on the distribution of the UE devices within the group in some situations. Where the UE devices are distributed in two distinct sets in the group, for example, two UE devices rather than one device may be selected for reporting as compared to a situation where all of the UE devices are close to each other and are distributed more uniformly. As discussed above, maintaining location information from more than one reporting UE device allows the base station to keep tracking the cluster if one of the reporting UE devices leaves the cluster. Where the speed of the reporting UE changes significantly compared to the other UE devices in the group, for example, the reporting UE may no longer be within the moving geographical area 904.

The selection of the specific UE devices may be based on the communication link quality to each UE device 401-404, 602 where the base station selects UE devices having the best link quality. Accordingly, the base station may measure received signals transmitted from the UE devices, such as uplink signals, and select UE devices having the highest received signal strength. For the example, base station 106 also selects the reporting UE devices based on measurement capabilities of the UE device. UE devices having multiple antennas and the ability to measure AoA of signals may be preferred to other UE devices, for example. Examples of other measurement capabilities that may be considered include whether the UE device has a GNSS receiver and whether the UE device has indoor location determination capability. In some situations, the selection of the reporting UE device may be based on other factors such as whether a UE device is a platoon leader (cluster head) for the group, for example. Since the cluster head is communicating with other devices in the group, the cluster head may be selected as a default reporting UE device. For the example, the base station selects UE device A 104 as a cluster head as a reporting UE device and also selects UE device D 602 as a reporting UE device.

As discussed above, the parameters related to how and when the location information is reported may be included in a location information request 118. The location reporting parameters may be based on several factors where some examples include, the mobility of the cluster relative to the base station, the mobility of UE devices relative to each other, the traffic-load at the base station, and the measurement capabilities of the UE device. The update periodicity (frequency of reporting) may be determined based on the mobility of the cluster relative to the base station and/or the mobility of UE devices relative to each other. Where the cluster is moving at relatively high speed, for example, the base station may require the reporting UE devices to provide location information more frequently as compared to lower speeds. Where the base station determines the UE devices are moving relative to each other at a high rate, the base station may select a lower update period (higher frequency for reporting). The link change triggers may also be determined based on the mobility.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A base station comprising:
a receiver configured to receive location information from a reporting user equipment (UE) device, the location information based at least partially on at least one measurement of a wireless signal received by the reporting UE device from a non-reporting UE device; and
a processor configured to determine a non-reporting UE device geographical location of the non-reporting UE device based at least partially on the location information.

2. The base station of claim 1, wherein the at least one measurement comprises a received signal strength of the wireless signal as received by the reporting UE device.

3. The base station of claim 2, wherein the at least one measurement comprises a device angle indicator of the wireless signal as received by the reporting UE device, the device angle indicator indicative of an angle between a base station direction and non-reporting UE device direction, the base station direction from the reporting UE device to the base station, the non-reporting UE device direction from the reporting UE device to the non-reporting UE device.

4. The base station of claim 3, wherein the location information comprises the received signal strength and wherein the processor is configured to determine an inter-UE distance between the non-reporting UE device to the reporting UE device based on the received signal strength and a transmission power of the wireless signal.

5. The base station of claim 4, wherein the location information comprises the AoA indicator and wherein the processor is configured to determine the non-reporting UE device geographical location based on a reporting UE distance between the reporting UE device and the base station, inter-UE distance, and the AoA indicator.

6. The base station of claim 3, wherein the location information comprises the non-reporting UE device location as Global Navigation Satellite System (GNSS) parameters.

7. The base station of claim 3, wherein the receiver is configured to receive the location information in a neighbor list that comprises location information for each neighbor mobile device of a plurality of neighbor mobile devices where each neighbor mobile device of the plurality of neighbor mobile devices has a wireless communication link quality above a threshold.

8. The base station of claim 7, wherein the neighbor list comprises cell identifier (Cell ID) information that identifies a serving cell for each neighbor mobile device.

9. The base station of claim 1, the base station further comprising:
a transmitter configured to transmit a location information request to the reporting UE device, the location information request instructing the reporting UE device to provide location information.

10. The base station of claim 9, wherein the location information request identifies the non-reporting UE device.

11. The base station of claim 9, wherein the location information request instructs the reporting UE device to provide location information for neighbor mobile devices.

12. The base station of claim 1, wherein the wireless signal is at least one of a sidelink signal, an uplink signal, and a beacon signal.

13. The base station of claim 1, wherein the wireless signal is without data and is at least one of an electromagnetic signal, a light signal, and a sound signal.

14. The base station of claim 1, wherein the processor is configured to determine the non-reporting UE device location without receiving a non-reporting UE device signal transmitted by the second mobile signal.

15. The base station of claim 1, wherein the processor is further configured to select determine the non-reporting UE device location without receiving a non-reporting UE device signal transmitted by the second mobile signal.

16. The base station of claim 1, wherein the wireless signal is transmitted by the non-reporting UE device.

17. A reporting user equipment (UE) device comprising:
a transmitter configured to transmit, to the base station, location information based on the wireless signal, the location information indicating to the base station a non-reporting UE device location of the non-reporting UE device without the base station receiving a non-reporting UE device signal transmitted from the non-reporting UE device.

18. The reporting UE device of claim 16, further comprising:
a receiver configured to receive a location information request from a base station, the location information request instructing the reporting UE device to provide location information, the receiver further configured to receive a wireless signal from a non-reporting UE device.

19. The reporting UE device of claim 17, wherein the location information is based at least partially on at least one measurement of the wireless signal transmitted by the non-reporting UE device and measured by the reporting UE device.

20. The reporting UE device of claim 19, further comprising:
a processor configured to determine:
an inter-UE distance between the non-reporting UE device and the reporting UE device based at least on a received signal strength of the wireless signal and a transmission signal strength of the wireless signal;
device angle indicator of the wireless signal, the device angle indicator indicative of an angle between a base station direction and a non-reporting UE device direction, the base station direction from the reporting UE device to the base station, the non-reporting UE device direction from the reporting UE device to the non-reporting UE device.

21. The reporting UE device of claim 20, wherein the location information comprises the received signal strength and the device angle indicator.

22. The reporting UE device of claim 20, wherein the location information comprises the non-reporting UE device location, the processor configured to determine the non-reporting UE device location at least partially based on the inter-UE distance, a base station distance between the reporting UE device and the base station, and the AoA indicator.

23. The reporting UE device of claim 17, wherein the transmitter is configured to transmit the location information in a neighbor list that comprises location information for each neighbor mobile device of a plurality of neighbor mobile devices.

24. The reporting UE device of claim 23, wherein the neighbor list comprises cell identifier (Cell ID) information that identifies a serving cell for each neighbor mobile device.

25. The reporting UE device of claim 17, wherein the location information request instructs the reporting UE device to provide location information for neighbor mobile devices.

26. The reporting UE device of claim 17, wherein the wireless signal is at least one of a sidelink signal, an uplink signal, and a beacon signal.

27. The reporting UE device of claim 17, wherein the wireless signal is at least one of an electromagnetic signal, a light signal, and a sound signal, the wireless signal without data.

28. The reporting UE device of claim 17, wherein the wireless signal comprises geographical location coordinates of the non-reporting UE device.
